(19) United States
(12) Patent Application Publication
(10) Pub. No.: US 2026/0211867 A1
(43) Pub. Date: Jul. 23, 2026

(54) DIGITAL ARTIFACT AUGMENTING WITH CONTEXTUAL TIMELINE DETAILS TRACKED VIA AUTOMATED BACKGROUND JOURNALING

(71) Applicant: MOTOROLA MOBILITY LLC, WILMINGTON, DE (US)

(72) Inventors: AMIT KUMAR AGRAWAL, BANGALORE (IN); KRISHNAN RAGHAVAN, BANGALORE (IN); NAKUL PATEL, NAGPUR (IN)

(21) Appl. No.: 19/032,263

(22) Filed: Jan. 20, 2025

(51) Int. Cl. G06F 16/23

(52) U.S. Cl. CPC G06F 16/2358

(57) ABSTRACT

An electronic device provides various techniques for augmenting a journal entry with content based on associating user activity (e.g., searches, chats, texts, emails, downloads). A processor of the electronic device is configured to cause the electronic device to monitor communication and actions occurring via and around the electronic device for contextual information. The processor is configured to cause the electronic device to store a timeline of the contextual information to a repository. In response to detecting creation of a digital artifact, the processor is configured to cause the electronic device to analyze content of the digital artifact and metadata associated with the digital artifact for subject information. The processor causes the electronic device to identify, from among the stored contextual information, additional content associated with the content and metadata of the digital artifact and store the digital artifact with the additional content as a journal entry for a timeline remembrance.

### BACKGROUND

### 1. Technical Field

The present disclosure relates generally to electronic devices capable of presenting visual and audio content, and more particularly to electronic devices that capture and store visual and audio content for later presentation.

### 2. Description of the Related Art

Electronic devices such as smartphones, tables, laptops, and desktop workstations are operated by users for a myriad of functions such as office automation, communication, and entertainment. Electronic devices are increasingly used as ubiquitously available means for chronicling significant events for a user. As an example, electronic devices can capture and store communication records (e.g., short message service (SMS) texts, emails, application direct messages). Also, electronic device can capture and store visual content (e.g., photographs, screen shots of presented documents) along with status information (e.g., time stamp and location) associated with the capture of the visual content. Additionally, electronic devices can capture and store audio content (e.g., audio streams received from a network entity and an audio input to a local microphone).

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1A presents a functional block diagram of example components of an electronic device in a communication environment and having hardware and software components that enable the features of the present disclosure to be advantageously implemented, according to one or more embodiments;

FIG. 1B is an additional block diagram representation of the electronic device of FIG. 1A presenting additional components, including components for wireless communications with other devices, according to one or more embodiments;

FIG. 2 illustrates a block communication diagram of a persistent journal assistant module of the electronic device configured to augment a journal entry with content based on associating user activity to the journal entry, according to one or more embodiments;

FIG. 3 illustrates a software platform diagram of an example artificial intelligence (AI) operating system (OS) of the electronic device that learns about a user of the electronic device to associate user activity with a journal entry, according to one or more embodiments;

FIG. 4 illustrates a display of the electronic device presenting a camera preview and a control to trigger capture of a journal entry, according to one or more embodiments;

FIG. 5 illustrates the display of the electronic device presenting a journal entry with a control indicating a number of content items based on associating user activities that could augment the journal entry, according to one or more embodiments;

FIG. 6 illustrates the display of the electronic device presenting a list of the content items available for selection to augment the journal entry, according to one or more embodiments;

FIG. 7 illustrates the display of the electronic device presenting an augmented journal entry, according to one or more embodiments;

FIG. 8 illustrates the display of the electronic device presenting an acknowledgement interface window containing acknowledgement of a contributor and control(s) to approve or disapprove of inclusion of the acknowledgement in the journal entry, according to one or more embodiments, and

FIGS. 9A-9C (collectively “FIG. 9”) are a flow diagram presenting a computer-implemented method for augmenting a journal entry with content, based on associating user activity to the journal entry, according to one or more embodiments.

### DETAILED DESCRIPTION

According to aspects of the present disclosure, an electronic device, a method, and a computer program provide various techniques for augmenting an electronic journal entry with additional content based on identifying and associating corresponding user activity (e.g., searches, chats, texts, emails, download links). The present disclosure provides improvements to blogging and journaling processes using an electronic device. Journaling has become integral to how many people chronicle their lives. What began with simple text entries has evolved into multimedia experiences, incorporating photos, videos, and audio recordings. This shift reflects a desire to construct a personal timeline, preserving memories and emotions digitally. Although automating some aspects has made journaling simpler, the user is still presented with a challenge to manually locate additional information that may have been created days, weeks, months or years in the past. With the passage of time, users often face the challenge of forgetting the context of events that led to creation of digital artifacts saved as journal entries. The actions and communications that precipitated the creation of these entries can be as significant as the artifacts themselves. In addition to forgetting, users may be limited by laziness or daunted by the effort required to backtrack through digital records to find associated user activities. Users may fail to record these crucial details and later regret the oversight.

The challenges in creating a comprehensive, robust journal entry highlights a clear need for a system capable of tracing back in time and aggregating all associated user actions, communications, and contextual information that contributed to the creation of each digital artifact, as provided by the present disclosure. As part of the benefits described herein, the electronic device is configured to enable users to capture and preserve a comprehensive narrative of their experiences and insights, ensuring that the full richness of their personal stories is documented and remembered. In particular, the present disclosure contemplates the accessibility of digital devices and the integration of artificial intelligence (AI) tools to significantly simplify and enhance capture, analysis, and highlighting of meaningful content. This technological evolution facilitates a broader cultural shift towards digital self-expression and introspection. Individuals may leverage this improved technology to not only record but also reflect upon their experiences in richer, more immersive ways.

According to one or more embodiments, an electronic device has a memory including (i) a persistent journal assistant application and (ii) a personal knowledge base (PKB). A processor of the electronic device is communicatively coupled to the memory. The processor is configured to cause the electronic device to monitor communication and actions occurring via and around the electronic device for contextual information. The processor is configured to cause the electronic device to store a timeline of the contextual information in a repository. In response to detecting creation of a digital artifact, the processor is configured to cause the electronic device to analyze content of the digital artifact and metadata associated with the digital artifact for subject information. The processor is configured to cause the electronic device to identify, from among the stored contextual information, additional content associated with the content and metadata of the digital artifact that can beneficially augment the digital artifact. The processor is configured to cause the electronic device to store, in the PKB, the digital artifact with the identified additional content as a journal entry for a timeline remembrance.

According to one or more embodiments, a computer-implemented method is provided for augmenting a journal entry with additional content based on associating user activity (e.g., searches, chats, texts, emails, download links). The method includes monitoring communication and actions occurring via and around an electronic device for contextual information. The method includes storing a timeline of the contextual information to a repository. In response to detecting the creation of a digital artifact, the method includes analyzing content of the digital artifact and metadata associated with the digital artifact for subject information. The method includes identifying, from among the stored contextual information, additional content associated with the content and metadata of the digital artifact. The method includes storing, in the PKB, the digital artifact with the additional content as a journal entry for a timeline remembrance.

Further embodiments provide a computer program product that includes: a non-transitory computer readable medium; and program code on the computer readable medium that, when processed by a processor of an electronic device, configures the processor and/or the electronic device to perform functions of the above-described method.

The above contains simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent within the following detailed description.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized, and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

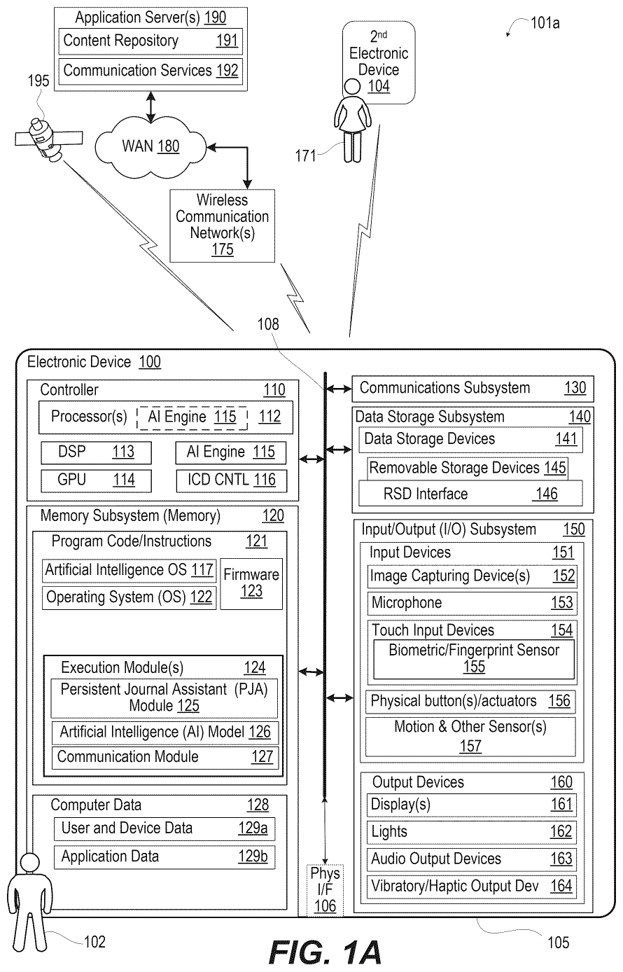

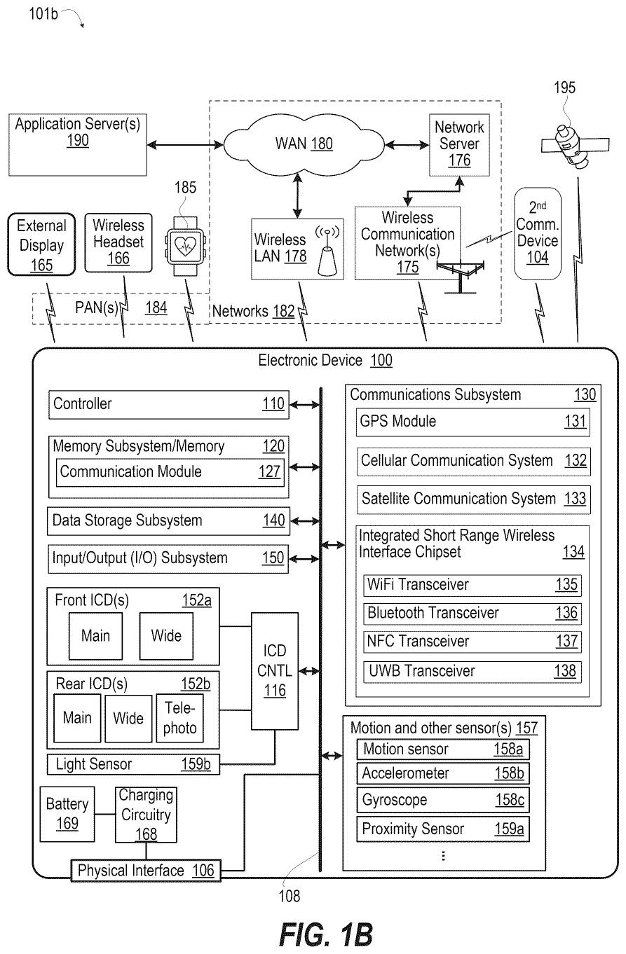

Those of ordinary skill in the art will appreciate that the hardware components and basic configuration depicted in the following figures may vary. For example, the illustrative components within electronic device 100 (FIG. 1A-1B) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural, functional, operational, or otherwise) on the described embodiments.

Referring now to the figures and beginning with FIG. 1A, there is illustrated a block diagram of an example electronic device 100 in communication environment 101a and having hardware and software components, which enable the features of the present disclosure to be advantageously implemented, according to one or more embodiments. Electronic device 100

Examples of electronic device 100 can include, but are not limited to, mobile devices, a notebook computer, a mobile phone, a smart phone, a digital camera with enhanced processing capabilities, a smart watch, a tablet computer, and other types of electronic devices. For purposes of this disclosure, electronic device is assumed to be a communication device that can be used to engage in a voice and/or video call with a second communication device. Electronic device 100 can therefore be interchangeably referred to herein as communication device 100.

Electronic device 100 generally includes controller 110, memory (or memory subsystem) 120, communication subsystem 130, data storage subsystem 140, input/output subsystem 150, all contained within or extended from an exterior surface of device housing 105. Controller 110 is shown communicatively connected/coupled via system interlink 108 with each of the subsystems 120, 130, 140, and 150, and is directly or indirectly connected with the individual components within each subsystem 120, 130, 140, and 150. System interlink 108 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components.

Controller 110 includes processor 112, which includes one or more central processing units (CPUs) or data processors. Processor 112 performs many of the features of controller 110 and references to features performed by controller 110 can be interchangeably referred to herein as features of processor 112, and vice-versa. In some embodiments, the various functions associated with controller 110 are integrated into processor 112, and accordingly, references made herein to controller and/or processor are understood to refer to one or both components as providing a single management component within the electronic device 100. For simplicity in describing the features of the electronic device 100, the operational functions provided by one or more of operational components within controller 110, including those provided by processor 112 are collectively described as being performed by controller 110. Collectively, components integrated within controller 110 support computing, classifying, processing, transmitting and receiving of data and information, and presenting of graphical and photographic images within a display.

As illustrated, controller 110 can also include one or more digital signal processors 113 graphics processing units (GPUs) 114, artificial intelligence (AI) engine 115, and image capturing device (ICD) controller 116. In some embodiments, the functionality of each of these additional processing components can be integrated with processor(s) 112. For example, processor 112 can, in some embodiments, include dedicated AI engine 115 and image signal processors (ISPs) (not shown). Processor 112 can further include other processors such as auxiliary processor(s) that may act as a low power consumption, always-on sensor hub for physical sensors.

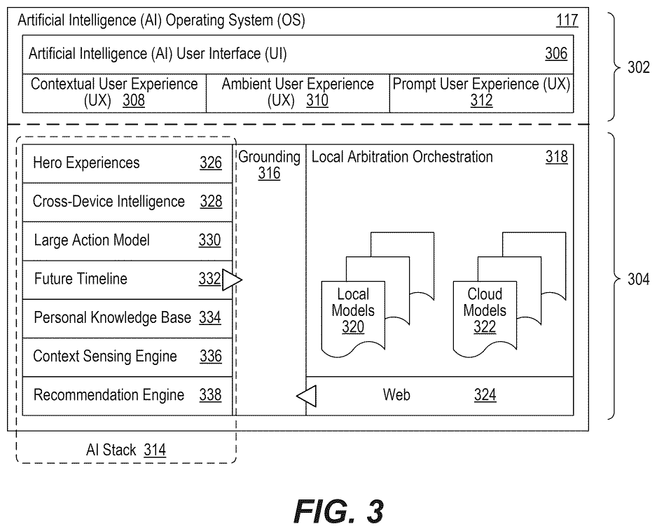

Controller 110 manages, and in some instances directly controls, the various functions and/or operations of electronic device 100. These functions and/or operations include, but are not limited to including, application data processing, communication, location and navigation tasks, image processing, and signal processing. In one or more alternate embodiments, electronic device 100 may use hardware component equivalents for application data processing and signal processing. For example, electronic device 100 may use special purpose hardware, dedicated processors, general purpose computers, microprocessor-based computers, micro-controllers, optical computers, analog computers, dedicated processors and/or dedicated hard-wired logic. Controller 110 can, in some embodiments, also include a hardware acceleration (HA) unit, which can establish direct memory access (DMA) sessions to route network traffic to various elements within electronic device 100 without direct involvement from processor 112 and/or a device operating system 122. Operating system 122 may include or be augmented by device AI operating system (OS) 117 that is described below with regard to FIG. 3.

Memory subsystem (or memory) 120 may include a combination of volatile and non-volatile memory, such as random-access memory (RAM) and read-only memory (ROM). Memory subsystem 120 stores instruction or program code 121 for execution by processor 112 to configure processor 112 (and more generally electronic device 100) to provide the operational functions and features described herein. Instructions/program code 121 (or program code 121 for short) includes instructions for an operating system (OS) 122, firmware 123, such as basic input/output system (BIOS) or Uniform Extensible Firmware Interface (UEFI). Program code 121 includes execution module(s) 124 that collectively provides the various features of the disclosure. Execution module(s) 124 include, without limitation, personal journal assistant (PJA) module 125, which provides the features and operating functionality of the disclosed embodiments when the corresponding program instructions of PJA module 125 are processed by/within processor 112/controller 110.

Execution modules 124 further includes AI model(s) 126. In one or more embodiments, processor 112 can utilize AI models 126 to provide AI functionality of processor-integrated AI engines 115. In other embodiments, AI models 126 are directly utilized by AI engine 115. In one or more embodiments, AI model 126 is integrated as a sub-module within PJA module 125 and is trained to support the AI features of PJA module 125. AI model(s) 126 may include an artificial neural network, a decision tree, a support vector machine, Hidden Markov model, linear regression, logistic regression, Bayesian networks, and so forth. AI model(s) 126 can be individually trained to perform specific tasks and can be arranged in different sets of AI models to generate different types of output. Training of AI model(s) 126 is the process by which AI models are trained to perform specific tasks or achieve certain objectives. The training involves providing the model with a large amount of data and allowing the model to learn from patterns and relationships within that data.

Each of the above-introduced module(s) and/or application(s) provides program instructions/code that are processed by processor 112 and which configures processor 112 (and/or controller 110) and/or other operational components of electronic device 100 to cause the electronic device 100 to perform specific operations and functions, as described herein. Descriptive names assigned to these modules add no functionality and are provided solely to assist in identifying the underlying features performed by processing the different modules. For example, PJA module 125 can include program instructions that cause or configure processor 112 to cause electronic device 100 to associate user activities with journal entries, such as by using natural language processing, image recognition, and audio speech recognition. Other features provided by PJA module 125 are described in further detail throughout this disclosure.

Program code 121 can further include instructions/code for other applications (not shown) providing different features of/within electronic device 100. In one or more embodiments, program code 121 may be integrated into a distinct chipset or hardware module as firmware that operates separately from other executable program code. Portions of program code 121 may be incorporated into different hardware components that operate in a distributed or collaborative manner.

Memory subsystem 120 also includes computer data 128. During execution of program code 121, processor 112 may access, use, generate, modify, store, or communicate computer data 128, such as user and device data 129a and application data 129b. Computer data 128 may incorporate “data” that originated as raw, real-world “analog” information that consists of basic facts and figures. Computer data 128 includes different forms of data, such as numerical data, images, coding, notes, and financial data, as well as data presenting video, graphics, text, and images. Computer data 128 may originate at electronic device 100 or may be retrieved from a remote device via communications subsystem 130. Electronic device 100 may store, modify, present, or transmit computer data 128.

Communications subsystem 130 includes various components that enable electronic device 100 to communicate with external communication networks and other devices, such as second electronic device 104 and application server(s) 190, etc., via communications subsystem 130. According to one or more embodiments, communication module 127 presented within program code 121 includes instructions supporting the use of communications subsystem 130 to establish communication interfaces enabling communication by electronic device 100 with these external networks and devices.

Data storage subsystem 140 of electronic device 100 includes data storage device(s) 141. Controller 110 is communicatively connected, via system interlink 108, to data storage device(s) 141. Data storage subsystem 140 provides stored versions of program code 121 and computer data 128 on nonvolatile storage that is accessible by controller 110. The program code 121 can be loaded into memory 120 for execution/processing by controller 110. In one or more embodiments, data storage device(s) 141 can include hard disk drives (HDDs), optical disk drives, and/or solid-state drives (SSDs), etc.

Data storage subsystem 140 of electronic device 100 can include removable storage device(s) (RSD(s)) 145, which is received in RSD interface 146. Controller 110 is communicatively connected to RSD 145, via system interlink 108 through RSD interface 146. In one or more embodiments, RSD 145 is a non-transitory computer program product or computer readable storage device that stores program code and associated data, including a copy of PJA module 125 and AI model(s) 126, which may be executed by a processor associated with a user device, such as electronic device 100. Controller 110 can access data storage device(s) 141 or RSD(s) 145 to provision electronic device 100 with stored program code 121 and computer data 128 that, when executed/processed by processor 112, the program code configures processor 112 and/or more generally electronic device 100, to provide the various functions described herein.

I/O subsystem 150 includes input devices 151 such as, but not limited to, image capturing device(s) (ICDs) 152, microphone 153, and touch input devices 154 (e.g., touch screens, keys, or buttons) for use by user 102 to interface with electronic device 100. Touch input devices 154 can include a biometric/fingerprint sensor 155 for biometric input. Biometric/fingerprint sensor 155 can be used to read/receive biometric data, such as fingerprints, to identify or authenticate a user. In some embodiments, the biometric sensor 155 can supplement an ICD (camera), which captures images for user detection/identification via facial recognition.

Input devices 151 may include physical buttons/actuators 156 that can be located on a periphery of the device housing 105. Physical buttons/actuators 156 may provide controls for volume, power, and ICDs 152. Microphone 153 can also be referred to as an audio input device. In some embodiments, microphone 153 may be used for identifying a user via voiceprint, voice recognition, and/or other suitable techniques. Input devices 151 can also include one or more motion or other sensor(s) 157, which are further defined in the FIG. 1B description which.

With reference to FIG. 1B, as illustrated, motion and other sensor(s) 157 of electronic device 100 include, but are not limited to, one or more motion sensor(s) 158a, one or more accelerometers 158b, one or more gyroscopes 158c, and proximity sensor 159a, etc. Motion sensor(s) 158a detects movement of electronic device 100 and provides motion data to processor 112 indicating the spatial orientation, position and movement of electronic device 100. Accelerometers 158b measure linear acceleration of movement of electronic device 100 in multiple axes (X, Y and Z). For example, accelerometers 158b can include three accelerometers, where one accelerometer measures linear acceleration in the X axis, one accelerometer measures linear acceleration in the Y axis, and one accelerometer measures linear acceleration in the Z axis. Accelerometers 158b can be used to calculate the orientation/position of electronic device 100 relative to the earth and can also be referred to as a gravity sensor. Gyroscope 158c measures rotation or angular rotational velocity of electronic device 100. Proximity sensor 159a senses the presence of nearby objects. In one embodiment, proximity sensor 159a can be an infrared (IR) sensor that detects the presence of a nearby object, such as when electronic device 100 is in a pocket of a user. Electronic device 100 can also include one or more light sensors 159b, which detects the luminance and/or intensity (i.e., the amount) of ambient light surrounding the electronic device 100.

Referring again to FIG. 1A, I/O subsystem 150 includes output devices 160 such as, but not limited to, display(s) 161, lights 162, audio output devices 163, and vibratory and/or haptic output devices 164. In one or more embodiments, electronic device 100 includes an integrated display 161 which incorporates a tactile, touch screen interface that can receive user's tactile/touch input. As a touch screen device, integrated display 161 allows a user to provide input to and/or to control electronic device 100 by touching features within a user interface presented on integrated display 161. Tactile, touch screen interface (154) can be utilized as an input device. The touch screen interface (154) can include one or more virtual buttons or selectable affordances. In one or more embodiments, when a user applies a finger or stylus on the touch screen interface (154) in the region demarked by the virtual button, the touch of the region causes the processor 112 to execute code to implement a function associated with the virtual button. In some implementations, integrated display 161 is integrated into a front surface of electronic device housing 105 along with front image capturing devices (not specifically shown), while the higher quality ICDs are located on a rear surface of device housing 105. Other embodiments provide multiple integrated displays within electronic device 100 and references to display(s) 161 are assumed to refer to one or all of these multiple integrated displays.

Vibration/haptic output device 164 can cause electronic device 100 to vibrate or shake when activated. Vibration/haptic output device 164 can be activated during an incoming call or message in order to provide an alert or notification to a user of electronic device 100. In one or more embodiments, integrated display 161, audio output devices (or speakers) 163, and vibration/haptic device 164 can generally and collectively be referred to as output devices.

With reference again to FIG. 1B and with continuing reference to FIG. 1A, there is presented another view of electronic device 100 with components enabling electronic device 100 to function as a mobile communication device, within an expanded communication environment 101b. In addition to the functional and operational components already presented by and described within the description of FIG. 1A, FIG. 1B further illustrates expanded communications subsystem 130 with additional communication components and interfaces enabling electronic device 100 to perform wireless communications within an expanded communication environment 101b that includes other devices.

Communications subsystem 130 includes global positioning system (GPS) module 131 that enables electronic device to communicate with and receive GPS location data from GPS satellite(s) 195. In one or more embodiments, GPS module 131 receives geospatial input from GPS broadcasts of time data and location data from GPS satellite(s) 195 to obtain geospatial location information about the physical location of electronic device 100.

In one or more embodiments, controller 110, via communications subsystem 130, performs multiple types of cellular over-the-air (OTA) or non-cellular wireless communication, such as by using a Bluetooth connection or other personal access network (PAN) connection. As shown, communications subsystem includes cellular communication system 132, which includes at least one radio frequency RF front end coupled to one or more antennas. In one or more embodiments, cellular communication system 132 can include a communication module with one or more baseband processors or digital signal processors, one or more modems, and a radio frequency (RF) front end having one or more transmitters and one or more receivers. In one or more embodiments, controller 110, via communications subsystem 130, may communicate via an OTA cellular connection with radio access networks (RANs) over a cellular wireless communication network (CWCN) 175. CWCN 175 can be a terrestrial network and include a plurality of base stations and associated network server(s) 176, in one embodiment. Cellular communication system 132 allows electronic device 100 to communicate wirelessly with CWCN 175 via transmissions of communication signals (represented as lightning bolts) to and from network communication devices, such as base stations or cellular nodes, of CWCN 175. Alternatively, or in addition, CWCN 175 can include a satellite network, and electronic device 100 connects to CWCN 175 using satellite communication system 133. Cellular communication system 132 and satellite communication system 133 enable electronic device 100 to engage in long distance wireless communication capabilities.

In one or more embodiments, communications subsystem 130 includes integrated short range wireless interface chipset 134 having one or more of Wi-Fi transceiver (TxRX) 135, Bluetooth (BT) TxRx 136, near field communication (NFC) transceiver 137, and ultra-wideband (UWB) transceiver 138. In one or more embodiments, the short-range communication devices are not integrated on a single chipset but can be separately provided hardware components. In one or more embodiments, electronic device 100 can communicate wirelessly with external wireless devices, such as a Wi-Fi router of a wireless local area network (WLAN) 178 and/or second electronic device 104, via one or more short-range wireless interface(s). Second electronic device 104 can be a communication device, such as a smartphone, and/or can be similarly configured as electronic device 100. Second user 171 may operate second electronic device 104. In one or more embodiments, electronic device 100 can receive Internet or Wi-Fi based calls, text messages, multimedia messages, and other notifications via a combination of wireless and wired networks (generally networks 182).

In one or more embodiments, networks 182 can include CWCN 175, WLAN 178, and Wide Area Network (WAN) 180, such as the Internet. In one or more embodiments, WAN 180 can enable electronic device 100 to access application servers 190, which can provide a downloadable version of PJA module 125 and/or access to other applications, online transactions, and resources. Application servers 190 may include one or content repository 191 that may be downloaded by electronic device 100 and be associated with a journal entry. Application servers 190 may include one or communication services 192 that facilitate communications that result communication records that may be associated with a journal entry.

In one or more embodiments, networks 182 can also include personal area networks (PAN) 184, which are individually created with second devices via one of short-range wireless devices from among Wi-Fi TxRX 135, BT TxRx 136, NFC transceiver 137, and UWB transceiver 138. Example second devices include external display 165, wireless headset 166, and wearable computing device 185. External display 165 can be a stand-alone monitor/display or a display integrated into a second electronic device, such as a laptop computer. In at least one embodiment, connection to the external display 165 can be wired and can include an intermediate connection device, such as a docking station device. In one or more embodiments, wearable computing device 185, such as a smartwatch, fitness tracker, or the like, may be paired with electronic device 100, and provide biometric data such as heart rate, breathing rate, and the like, to the electronic device 100 via the paired communication link.

Electronic device 100 also includes a physical interface 106. Physical interface 106 of electronic device 100 can serve as an input/output data port and can be used as a power supply port that is coupled to charging circuitry 168 which feeds electrical power to device battery 169 to enable recharging of device battery 169 and/or powering of electronic device 100. As a data port, physical interface 106 can enable electronic device 100 to be physically coupled via a cable or docking station port to a second device, such as external display 165.

FIG. 1B also presents additional details of ICD(s) 152 of electronic device 100. Throughout the disclosure, the term image capturing device (ICD) is synonymous with and/or utilized interchangeably with any one of the cameras of electronic device 100. ICD(s) (or cameras) 152 includes front cameras 152a and rear cameras 152b. In one embodiment, each of front cameras 152a and rear cameras 152b are communicatively coupled to ICD controller 116. ICD controller 116 supports the processing of image data from front cameras 152a and rear cameras 152b. Front cameras 152a can include a main camera and a wide-angle camera. Rear ICD(s) can include a main camera, a wide-angle camera, and a telephoto camera. Both sets of cameras 152 include image sensors that can capture images that are within the field of view (FOV) of each respective camera 152. In one or more embodiments, one or more of the cameras can be utilized to enable biometric authentication using facial image or iris scan recognition.

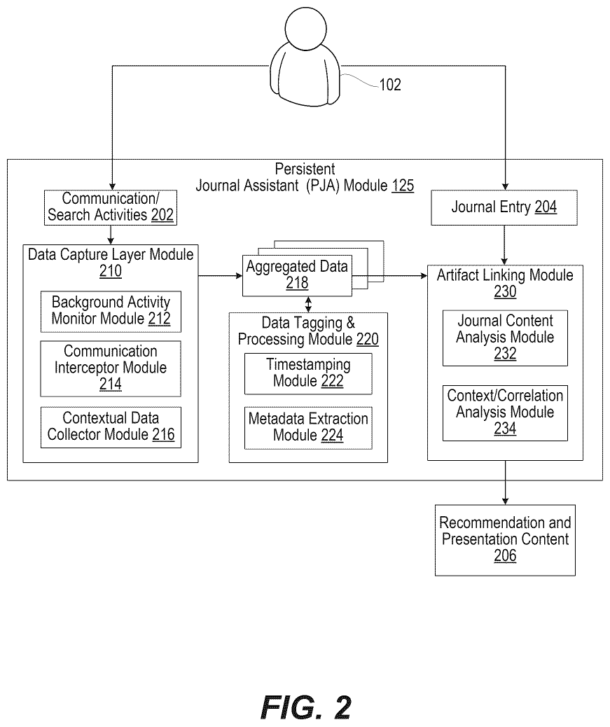

FIG. 2 illustrates a block communication diagram of a persistent journal assistant (PJA) module 125 of electronic device 100 (FIG. 1A) configured to augment a journal entry with content based on associating user activity (e.g., searches, chats, texts, emails, download links). In part, PJA module 125 creates essential elements as additional content for a timeline blog associated with a digital artifact. User 102 interacts over time with electronic device 100 (FIG. 1A) by generating or receiving communication/search activities 202. Subsequently, user 102 triggers creation of journal entry 204, prompting PJA module 125 to generate recommendation and presentation content 206 to augment journal entry 204. In one or more embodiments, to accomplish this result, PJA module 125 may include data capture layer module 210 that in turn includes background activity monitor module 212, communication interceptor module 214 and contextual data collector module 216. Background activity monitor module 212 identifies and monitors activities by applications executed by electronic device 100 and identifies particular activities relevant to creating a timeline of user activity. Communication interceptor module 214 parses information from incoming and outgoing communication that may be related to a timeline. Contextual data collector module 216 captures additional information such as preceding and subsequent events that indicate an association with other timeline events. In one or more embodiments, PJA module 125 stores and organizes the captured activity data from various sources in a centralized storage database, such as personal knowledge base (PKB) 334 (FIG. 3). Data capture layer module 210 stores in memory aggregated data 218 for further processing. In particular, PJA module 125 includes data tagging and processing module 220, which includes timestamping module 222 to timestamp the aggregated data 218 and metadata extraction module 224 to find additional contextual data contained within communication records, downloaded links, etc. PJA module 125 includes artifact linking module 230 that includes journal content analysis module 232 and content/correlation analysis module 234. Artifact linking module 230 accesses journal entry 204 and data mines aggregated data 218 to find additional content.

In one or more embodiments, data capture layer module 210 monitors the user activity (e.g., communication/search activities 202) and contextually capture contextual data of any user activity. In response to detecting initial creation of journal entry 204, artifact linking module 230 detects a sequence of connected events leading to the digital artifact (i.e., journal entry 204) based off of user activity. In one or more embodiments, PJA module 125 may process aggregated data 218 to remove irrelevant or sensitive information such as to ensure privacy. PJA module 125 may process aggregated data 218 to enrich data by adding tags, keywords, or summaries to facilitate search and analysis. PJA module 125 may process aggregated data 218 to categorize the data by grouping similar data points to identify patterns and relationships.

With PJA module 125 having persistently tracked user activities and related content, PJA module 125 is prepared to respond to the creation of journal entry 204. In an example, PJA module 125 may analyze content of journal entry 204 to identify relevant keywords, themes or topics. PJA module 125 performs a contextual matching with the earlier captured aggregated data 218 based on different attributes like keywords, timestamps, etc. Based on the linked data, PJA module 125 suggests to the user to add (annotate) relevant contextual information to journal entry 204 and allows user to explore linked data/annotations. Additionally, PJA module 125 may allow the user to provide feedback on the accuracy of recommendation to use as feedback loop for further tagging and matching algorithms.

FIG. 3 illustrates a software platform diagram of an example artificial intelligence (AI) operating system (OS) 117. By learning about the user, AI OS 117 can anticipate future actions of the user and provide recommendations for the user, improving user experience. AI OS 117 supports functionality of PJA module 125 (FIG. 1A) that adds functionality for learning user interests and using the learned user interest to curate push notifications for promoted content. AI OS 117 includes user plane 302 supported by control plane 304. User plane includes AI user interface (UI) 306 that supports contextual user experience (UX) component 308, ambient UX component 310, and prompt UX component 312. Control plane 304 includes AI agents 314 that communicate via grounding component 316 to local arbitration orchestration component 318 having local models 320 and cloud models 322. AI agents 314 communicates via grounding component 316 to web interface 324. AI agents 314 includes hero experiences agent 326, cross-device intelligence agent 328, large action model 330, future timeline 332, personal knowledge base (PKB) 334, context sensing engine 336, and recommendation engine 338.

User experience (UX) design is defined as a multidisciplinary field that focuses on enhancing the overall experience that individuals have when interacting with a digital product, system, or service. UX design encompasses various aspects of user interaction, including usability, accessibility, aesthetics, and overall satisfaction. UX design aims to create meaningful and positive experiences for users by understanding their needs, behaviors, and preferences.

Grounding component 316 in AI is an essential process that ensures AI systems comprehend and interact with the real world accurately. Grounding is a bridge between abstract AI concepts and practical, tangible outcomes. Grounding allows AI systems to bridge semantic gaps in the real world, team with other agents in such environments, process inputs from the environment, and learn from interactions. A successful synthetic teammate requires several cognitive capacities, including situation assessment, task behavior, language comprehension and generation, and knowledge gap resolution processes. Grounding enables agents with different capabilities to communicate.

In one or more embodiments, AI OS 117 provides functionality to respond to a user input of “Pay attention” by listening, transcribing, and summarizing audio in the background, enabling a user to focus on listening without having to actively take notes. AI OS 117 may record in the background of other activities and save audio recordings to a journal entry in PKB 334. AI OS 117 may suggest a title for the recording. In another example, AI OS 117 may respond to a user input of “remember this” by saving screenshots, photos and other items currently being presented to user 102 (FIG. 1A) to a journal entry in PKB 334. AI OS 117 may suggest a title for the images. In an additional example, AI OS 117 provides functionality to respond to a user input of “Recall” by providing a personalized search based on audio, images and other saved information in PKB 334 as queried by user 102 (FIG. 1A). AI OS 117 may categorize and perform pattern recognition of the journal entries and create reminders as indicated by the recognized patterns.

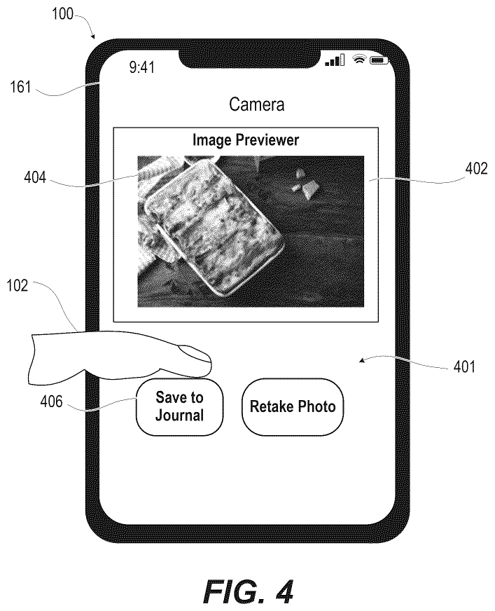

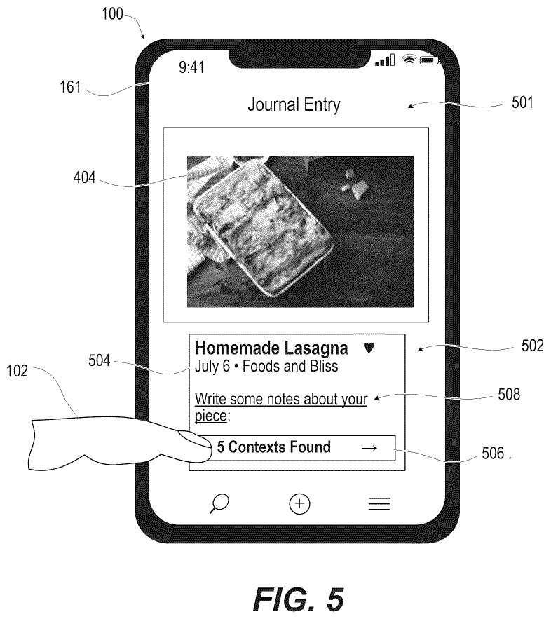

FIG. 4 illustrates display 161 of electronic device 100 presenting user interface window 401 including camera preview 402 with a digital artifact of image 404 of a dish of lasagna. User interface window 401 also presents control 406 to trigger capture of a journal entry. FIG. 5 illustrates display 161 of electronic device 100 presenting user interface window 501 including journal entry 502 that includes the digital artifact (i.e., image 404) and automatically or manually generated title and summary block 504. Context control 506 indicates that a number of content items are available to augment journal entry 502 based on associating user activities with journal entry 502. User interface window 501 contains manual user input segment 508 for receiving manual entry of additional content.

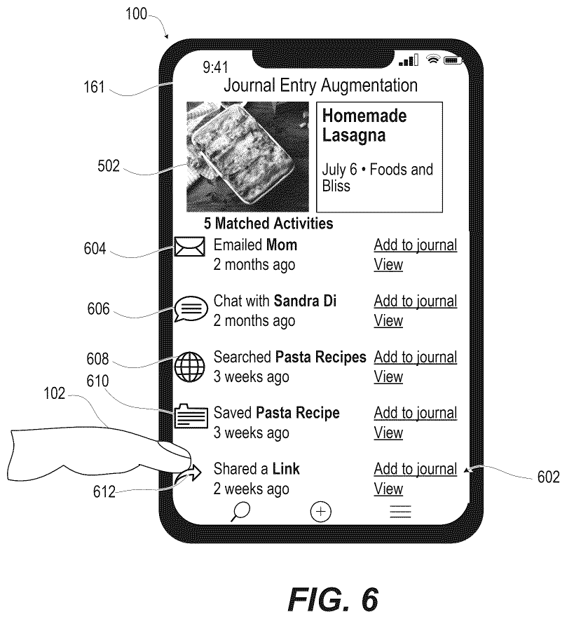

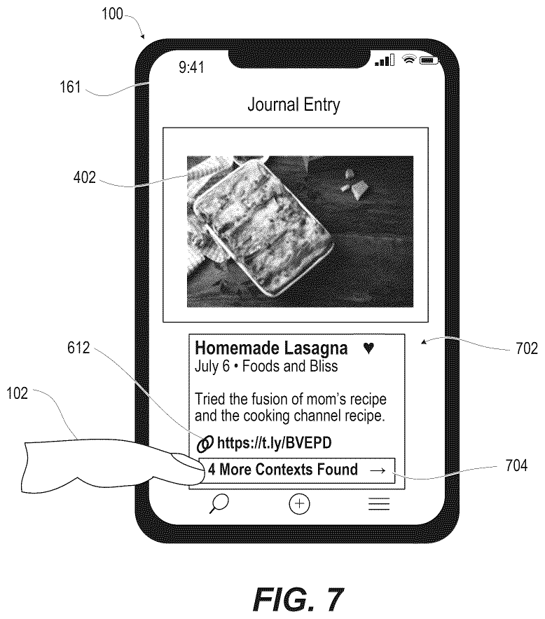

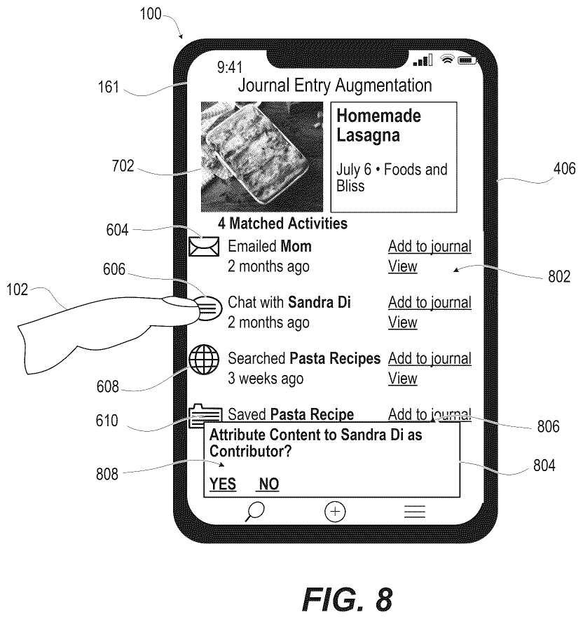

FIG. 6 illustrates display 161 of electronic device 100 presenting list 602 of the content items (e.g., emails, chats, web search links, downloaded documents, shared links, etc.) available for selection to augment journal entry 502. Journal entry 502, which is not yet augmented, is presented. List 602 includes email item 604, chat item 606, search item 608, download item 610, and link item 612. FIG. 7 illustrates display 161 of electronic device 100 presenting augmented journal entry 702 that includes link item 612 approved by user 102 for inclusion. Additional item(s) control 704 provides an opportunity for considering and including more of remaining items 604, 606, 608, and 610 of FIG. 6. User 102 triggers additional item(s) control 704. FIG. 8 illustrates display 161 of electronic device 100 with presentation of remaining list 802 of available associated context items 604, 606, 608, and 610. In response to user 102 triggering chat item 606, electronic device 100 incorporates the additional content contained in chat item 606 into augmented journal entry 702. In addition, in response to determining that additional content contained in chat item 606 originated from another person “Sandra Di”, electronic device 100 presents acknowledgement interface window 804 containing acknowledgement 806 of an identified contributor and control(s) 808 to approve or disapprove of inclusion of acknowledgement in augmented journal entry 702. In response to user triggering “Yes”, electronic device 100 adds an attribution for Sandra Di providing the additional content contained in chat item 606. In response to user not triggering “Yes”, such as by selecting “No” or not providing a selection of control(s) 808 over a period of time, electronic device 100 does not include an attribution for the additional content contained in chat item 606.

With particular reference to FIG. 1A, according to aspects of the present disclosure, electronic device 100 has memory 120 including (i) persistent journal assistant (PJA) module 125 and (ii) personal knowledge base (PKB) 334. Processor 112 is communicatively coupled to memory 120. Processor 112 is configured to cause electronic device 100 to monitor communication and actions occurring via and around electronic device 100 for contextual information. Processor 112 is configured to cause electronic device 100 to store a timeline of the contextual information to a repository (e.g., memory 120). In response to detecting creation of a digital artifact, processor 112 is configured to cause electronic device 100 to analyze content of the digital artifact and metadata associated with the digital artifact for subject information. Processor 112 is configured to cause electronic device 100 to identify, from among the stored contextual information, additional content associated with the content and metadata of the digital artifact. Processor 112 is configured to cause electronic device 100 to store, in the PKB, the digital artifact with the additional content as a journal entry for a timeline remembrance.

In one or more embodiments, the additional content is retrieved from at least one stored contextual information including one or more communication records associated with the subject information and originating from or directed to user 102 of electronic device 100. In one or more embodiments, electronic device 100 includes at least one user input device 151 communicatively coupled to processor 112. In response to receiving, via at least one input device 151, a user trigger to capture the digital artifact, processor 112 is configured to cause electronic device 100 to concurrently capture and/or retrieve, as the additional content, at least one of a group including: (i) an audio recording; (ii) a video recording; (iii) an image; (iv) a user input description. The additional content is external to the digital artifact. In one or more particular embodiments, in response to identifying a contributor of the additional content that is not user 102, processor 112 is further configured to cause electronic device 100 to store, as a journal entry in PKB 334 (FIG. 3), an acknowledgement of a contributor of the additional content for the timeline remembrance associated with the digital artifact.

In one or more specific embodiments, electronic device 100 includes one or more input devices 151 communicatively connected to processor 112. Electronic device 100 includes one or more output devices 160 communicatively connected to processor 112. Processor 112 is configured to cause electronic device 100 to generate and present, via one or more output device 160, acknowledgement interface window 804 (FIG. 8) containing the acknowledgement of the contributor and control 808 to approve or disapprove of inclusion in augmented journal entry 702. Processor 112 is configured to cause electronic device 100 to store the acknowledgement of the contributor with the digital artifact (i.e., augmented journal entry 702), in response to receiving, via one or more input device 151, a user input approving the inclusion. In one or more very specific embodiments, processor 112 is configured to cause electronic device 100 to store a disapproval record for inclusion of the contributor in response to receiving a user input disapproving the inclusion.

In one or more embodiments, electronic device 100 includes artificial intelligence (AI) engine 115 trained to analyze content and metadata for subject information using one or more of image recognition, audible speech recognition, and natural language processing. In analyzing the content of the digital artifact and the metadata associated with the digital artifact for subject information, processor 112 is configured to cause electronic device 100 to recognize and parse, using AI engine 115, the content and the metadata to identify the subject information. In one or more particular embodiments, processor 112 is configured to cause electronic device 100 to recognize and parse, using AI engine 115, the stored contextual information for additional content associated with the subject information.

In one or more embodiments, processor 112 is configured to cause electronic device 100 to monitor user activity at electronic device 100 related to receiving or generating the contextual information. Processor 112 is further configured to cause electronic device 100 to capture the contextual information. Processor 112 is further configured to cause electronic device 100 to identify the additional content from among the stored contextual information, at least in part based on detecting a sequence of connected events leading to capture of the digital artifact based on the contextual information.

In one or more embodiments, electronic device 100 includes one or more input device 151 communicatively connected to processor 112. Electronic device 100 includes one or more output device 160 communicatively connected to processor 112. Prior to storing the digital artifact with the additional content as a journal entry for a timeline remembrance in PKB 334 (FIG. 3), processor 112 is further configured to cause electronic device 100 to generate and render, via one or more output devices 160, user interface window 401 (FIG. 4) containing the additional content (e.g., image 404) and control 406 for approving or disapproving inclusion of the additional content with the digital artifact. Processor 112 is further configured to cause electronic device 100 to generate the digital artifact to further include the additional content, in response to receiving an approval user input via one or more input device 151.

In one or more embodiments, electronic device 100 includes one or more input devices 151 communicatively connected to processor 112. Electronic device 100 includes one or more output devices 160 communicatively connected to processor 112. Processor 112 is further configured to cause electronic device 100 to generate and render, via one or more input device 160, user interface window 501 that contains manual user input segment 508 for receiving manual entry of additional content. In response to receiving the manual entry, via one or more input device 151, processor 112 is further configured to cause electronic device 100 to generate the digital artifact to further include the additional content.

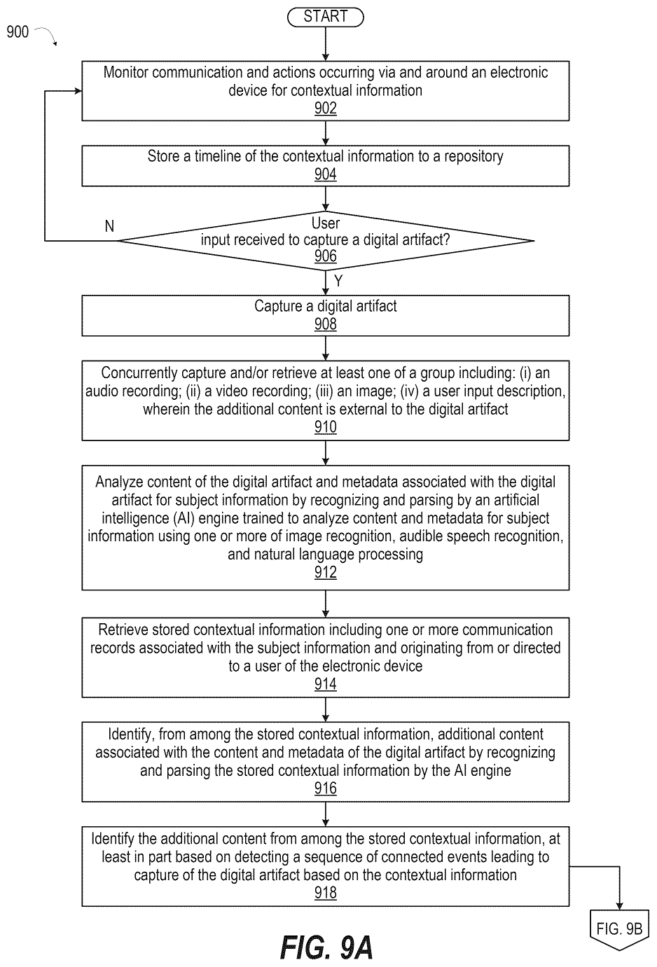

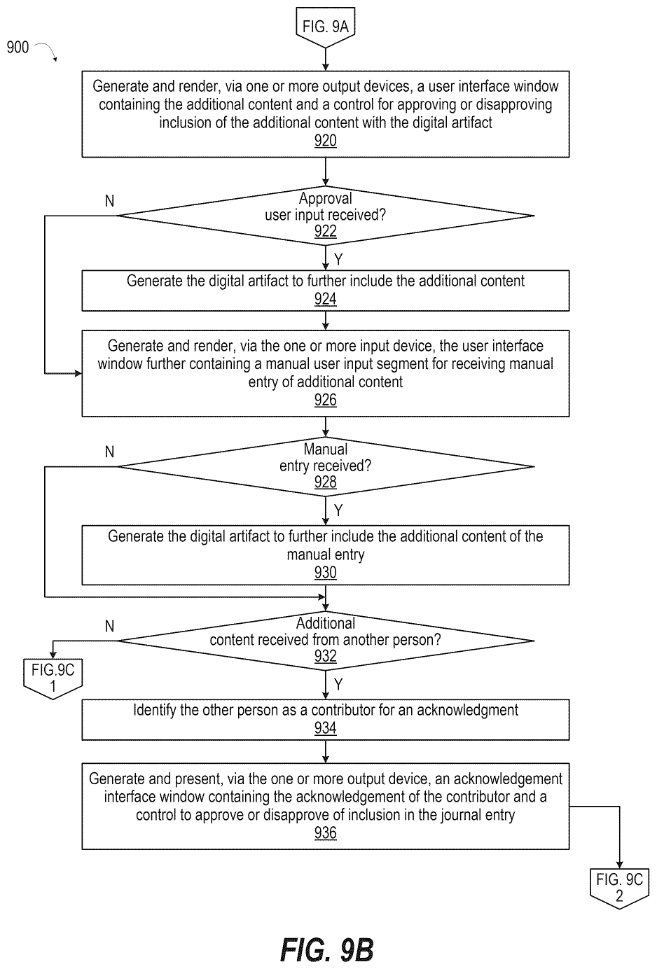

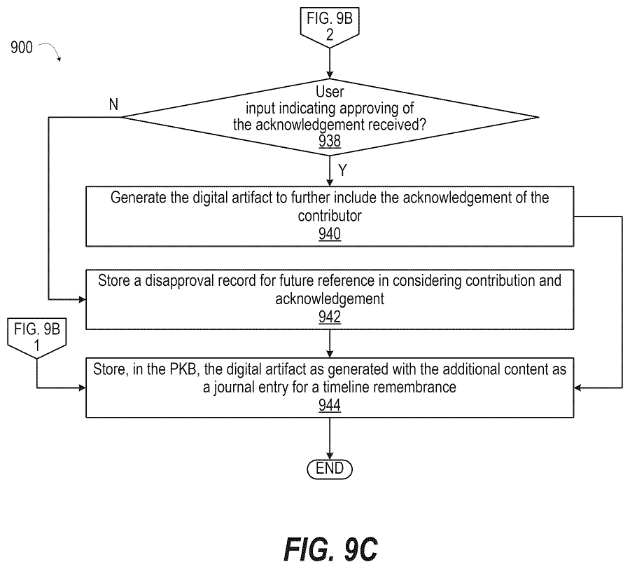

FIGS. 9A-9C (collectively “FIG. 9”) are a flow diagram presenting a computer-implemented method for augmenting a journal entry with content based on associating user activity (e.g., searches, chats, texts, emails, download links), The description of method 900 (FIG. 9) is provided with general reference to the specific components illustrated within the preceding FIGS. 1A-1B and 2-8. Specific components referenced in method 900 (FIG. 9) may be identical or similar to components of the same name used in describing preceding FIGS. 1A-1B and 2-8. In one or more embodiments, controller 110 (FIG. 1A) configures electronic device 100 (FIGS. 1A-1B) or a similar computing device to provide the described functionality of method 900 (FIG. 9).

With reference to FIG. 9A, method 900 includes monitoring communication and actions occurring via and around an electronic device for contextual information (block 902). Method 900 includes storing a timeline of the contextual information to a repository (block 904). Method 900 includes determining whether a user input is received to capture a digital artifact (decision block 906). In response to determining that the user input is not received to capture the digital artifact, method 900 returns to block 902. In response to determining that the user input is received to capture the digital artifact, method 900 includes capturing a digital artifact (block 908). Method 900 includes concurrently capturing and/or retrieving additional content from among at least one of a group including: (i) an audio recording; (ii) a video recording; (iii) an image; and (iv) a user input description, where the additional content is external to the digital artifact (block 910). Method 900 includes analyzing content of the digital artifact and metadata associated with the digital artifact for subject information by recognizing and parsing by an artificial intelligence (AI) engine trained to analyze content and metadata for subject information using one or more of image recognition, audible speech recognition, and natural language processing (block 912). Method 900 includes retrieving stored contextual information including one or more communication records associated with the subject information and originating from or directed to a user of the electronic device (block 914). Method 900 includes identifying, from among the stored contextual information, additional content associated with the content and metadata of the digital artifact by recognizing and parsing the stored contextual information by the AI engine (block 916). Method 900 includes identifying the additional content from among the stored contextual information, at least in part based on detecting a sequence of connected events leading to capture of the digital artifact based on the contextual information (block 918). Then method 900 proceeds to block 920 of FIG. 9B.

With reference to FIG. 9B, method 900 includes generating and rendering, via one or more output devices, a user interface window containing the additional content and a control for approving or disapproving inclusion of the additional content with the digital artifact (block 920). Method 900 includes determining whether an approval user input is received via the one or more input devices (decision block 922). In response to receiving an approval user input via the one or more input device, method 900 includes generating the digital artifact to further include the additional content (block 924). In an example, an augmented journal entry maintained by the electronic device is an aggregation of content and links to content that may be rendered and presented via an output device to a user. Examples of content include images, videos, audio, and text. The augmented journal entry may be stored in a personal knowledge base or in other computer-readable data structures. In response to not receiving an approval user input (e.g., an explicit disapproval user input or no user input) via the one or more input device in decision block 922 or after generating the digital artifact with additional content in block 924, method 900 may include generating and rendering, via the one or more input device, a modified user interface window further containing a manual user input segment for receiving manual entry of additional content (block 926). Method 900 may include determining whether a manual entry is received via the one or more input devices (decision block 928). In response to receiving the manual entry, method 900 includes generating the digital artifact to further include the additional content of the manual entry (block 930). In response to not receiving the manual entry store in decision block 928 or after generating the digital artifact in block 930, method 900 includes determining whether the additional content was received from another person (decision block 932). In response to determining that the additional content is not received from another person, method 900 proceeds to block 944 of FIG. 9C. With continued reference to FIG. 9B, in response to determining that the additional content is received from the other person, method 900 includes identifying the other person as a contributor for an acknowledgment (block 934). Method 900 includes generating and presenting, via the one or more output devices, an acknowledgement interface window containing the acknowledgement of the contributor and a control to approve or disapprove of inclusion in the journal entry (block 936). Then method 900 proceeds to block 938 of FIG. 9C.

With reference to FIG. 9C, method 900 may include determining whether a user input indicating approving of the acknowledgement is received via the one or more input devices (decision block 938). In response to receiving the user input indicating approving of the acknowledgement, method includes generating the digital artifact to further include the acknowledgement of the contributor (block 940). In response to not receiving the user input indicating approving of the acknowledgement (e.g., explicit disapproval or no user input), method 900 may include storing a disapproval record for future reference in considering contribution and acknowledgement to the digital artifact (block 942). In response to determining that the additional content is not received from the other person in decision block 932 (FIG. 9B) or after either approving or disapproving in block 940 and 942, method 900 includes storing, in the PKB, the digital artifact as generated with the additional content as a journal entry for a timeline remembrance (block 932). Then method 900 ends

According to aspects of the present disclosure, method 900 may include monitoring communication and actions occurring via and around an electronic device for contextual information. Method 900 may include storing a timeline of the contextual information to a repository. In response to detecting the creation of a digital artifact, method 900 may include analyzing content of the digital artifact and metadata associated with the digital artifact for subject information. Method 900 may include identifying, from among the stored contextual information, additional content associated with the content and metadata of the digital artifact. Method 900 may include storing, in a personal knowledge base (PKB), the digital artifact with the additional content as a journal entry for a timeline remembrance.

In one or more embodiments, method 900 may further include retrieving the additional content from at least one stored contextual information including one or more communication records associated with the subject information and originating from or directed to a user of the electronic device. In one or more embodiments, in response to receiving, via at least one input device, a user trigger to capture the digital artifact, method 900 may further include concurrently capturing and/or retrieving at least one of a group comprising: (i) an audio recording; (ii) a video recording; (iii) an image; and (iv) a user input description. The additional content is external to the digital artifact. In one or more particular embodiments, in response to identifying a contributor of the additional content that is not the user, method 900 may further include storing, as a journal entry in the PKB, an acknowledgement of a contributor of the additional content for the timeline remembrance associated with the digital artifact. In one or more specific embodiments, method 900 may further include generating and presenting, via one or more output device, an acknowledgement interface window containing the acknowledgement of the contributor and a control to approve or disapprove of inclusion in the journal entry. Method 900 may further include storing the acknowledgement of the contributor with the digital artifact, in response to receiving, via one or more input device, a user input approving the inclusion. Method 900 may further include storing a disapproval record for inclusion of the contributor in response to receiving a user input disapproving the inclusion.

In one or more embodiments, method 900 may further include monitoring user activity at the electronic device related to receiving or generating the contextual information. Method 900 may include capturing the contextual information. Method 900 may include identifying the additional content from among the stored contextual information, at least in part based on detecting a sequence of connected events leading to capture of the digital artifact based on the contextual information.

In one or more embodiments, prior to storing the digital artifact with the additional content as a journal entry for a timeline remembrance in the personal knowledge base, method 900 may further include generating and rendering, via one or more output devices, a user interface window containing the additional content and a control for approving or disapproving inclusion of the additional content with the digital artifact. Method 900 may include generating the digital artifact to further comprise the additional content, in response to receiving an approval user input via the one or more input device. Method 900 may include generating and rendering, via the one or more input device, a user interface window containing a manual user input segment for receiving manual entry of additional content. In response to receiving the manual entry, via one or more input devices, method 900 may further include generating the digital artifact to further comprise the additional content.

According to aspects of the present disclosure, the electronic device 100 (FIG. 1A), method 900 (FIG. 9) and computer program product, such as RSD 145 (FIG. 1A), provide techniques for augmenting a journal entry with content based on associating user activity (e.g., searches, chats, texts, emails, download links). By persistently capturing and analyzing user activities, potential timeline events are available to more fully describe what inputs led to creating a journal entry. User 102 (FIG. 1A) does not need to manually categorize activities over a long period, especially when journaling these activities is not even contemplated initially. During creation of the digital artifact, additional content is automatically identified for relevance and presented for inclusion.

Aspects of the present innovation are described above with reference to flowchart illustrations and/or block diagrams of methods, apparatus (systems) and computer program products according to embodiments of the innovation. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

As will be appreciated by one skilled in the art, embodiments of the present innovation may be embodied as a system, device, and/or method. Accordingly, embodiments of the present innovation may take the form of an entirely hardware embodiment or an embodiment combining software and hardware embodiments that may all generally be referred to herein as a “circuit,” “module” or “system.”

While the innovation has been described with reference to exemplary embodiments, it will be understood by those skilled in the art that various changes may be made, and equivalents may be substituted for elements thereof without departing from the scope of the innovation. In addition, many modifications may be made to adapt a particular system, device, or component thereof to the teachings of the innovation without departing from the essential scope thereof. Therefore, it is intended that the innovation not be limited to the particular embodiments disclosed for carrying out this innovation, but that the innovation will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the innovation. As used herein, the singular forms “a”, “an” and “the” are intended to include the plural forms as well, unless the context clearly indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present innovation has been presented for purposes of illustration and description but is not intended to be exhaustive or limited to the innovation in the form disclosed. Many modifications and variations will be apparent to those of ordinary skill in the art without departing from the scope and spirit of the innovation. The embodiments were chosen and described in order to best explain the principles of the innovation and the practical application, and to enable others of ordinary skill in the art to understand the innovation for various embodiments with various modifications as are suited to the particular use contemplated.

What is claimed is:

1. An electronic device comprising:
a memory comprising (i) a persistent journal assistant application; and (ii) a personal knowledge base (PKB); and
a processor communicatively coupled to the memory, and which is configured to cause the electronic device to:
monitor communication and actions occurring via and around the electronic device for contextual information;
store a timeline of the contextual information to a repository; and
in response to detecting creation of a digital artifact:
analyze content of the digital artifact and metadata associated with the digital artifact for subject information;
identify, from among the stored contextual information, additional content associated with the content and metadata of the digital artifact; and
store, in the PKB, the digital artifact with the additional content as a journal entry for a timeline remembrance.

2. The electronic device of claim 1, wherein the additional content is retrieved from at least one stored contextual information comprising one or more communication records associated with the subject information and originating from or directed to a user of the electronic device.

3. The electronic device of claim 1, further comprising at least one user input device communicatively coupled to the processor, and wherein the processor is configured to cause the electronic device to:
in response to receiving, via the at least one input device, a user trigger to capture the digital artifact, concurrently capture and/or retrieve at least one of a group comprising: (i) an audio recording; (ii) a video recording; (iii) an image; (iv) a user input description, wherein the additional content is external to the digital artifact.

4. The electronic device of claim 3, wherein the processor is configured to cause the electronic device to:
in response to identifying a contributor of the additional content that is not the user, store, as a journal entry in the PKB, an acknowledgement of a contributor of the additional content for the timeline remembrance associated with the digital artifact.

5. The electronic device of claim 4, further comprising:
one or more input devices communicatively connected to the processor; and
one or more output devices communicatively connected to the processor;
wherein the processor is configured to cause the electronic device to:
generate and present, via the one or more output device, an acknowledgement interface window containing the acknowledgement of the contributor and a control to approve or disapprove of inclusion in the journal entry; and
store the acknowledgement of the contributor with the digital artifact, in response to receiving, via the one or more input device, a user input approving the inclusion.

6. The electronic device of claim 5, wherein the processor is configured to cause the electronic device to:
store a disapproval record for inclusion of the contributor in response to receiving a user input disapproving the inclusion.

7. The electronic device of claim 1, further comprising an artificial intelligence (AI) engine trained to analyze content and metadata for subject information using one or more of image recognition, audible speech recognition, and natural language processing, and wherein, in analyzing the content of the digital artifact and the metadata associated with the digital artifact for subject information, the processor is configured to cause the electronic device to:
recognize and parse, using the AI engine, the content and the metadata to identify the subject information.

8. The electronic device of claim 7, wherein the processor is configured to cause the electronic device to:
recognize and parse, using the AI engine, the stored contextual information for additional content associated with the subject information.

9. The electronic device of claim 1, wherein the processor is configured to cause the electronic device to:
monitor user activity at the electronic device related to receiving or generating the contextual information;
capture the contextual information; and
identify the additional content from among the stored contextual information, at least in part based on detecting a sequence of connected events leading to capture of the digital artifact based on the contextual information.

10. The electronic device of claim 1, further comprising:
one or more input devices communicatively connected to the processor; and
one or more output devices communicatively connected to the processor;
wherein the processor is configured to cause the electronic device to:
prior to storing the digital artifact with the additional content as a journal entry for a timeline remembrance in the personal knowledge base:
generate and render, via the one or more output devices, a user interface window containing the additional content and a control for approving or disapproving inclusion of the additional content with the digital artifact; and
generate the digital artifact to further comprise the additional content, in response to receiving an approval user input via the one or more input device.

11. The electronic device of claim 1, further comprising:
one or more input devices communicatively connected to the processor; and
one or more output devices communicatively connected to the processor;
wherein the processor is configured to cause the electronic device to:
generate and render, via the one or more input device, a user interface window containing a manual user input segment for receiving manual entry of additional content; and
in response to receiving the manual entry, via the one or more input device, generate the digital artifact to further comprise the additional content.

12. A method comprising:
monitoring communication and actions occurring via and around an electronic device for contextual information;
storing a timeline of the contextual information to a repository; and
in response to detecting creation of a digital artifact:
analyzing content of the digital artifact and metadata associated with the digital artifact for subject information;
identifying, from among the stored contextual information, additional content associated with the content and metadata of the digital artifact; and
storing, in a personal knowledge base (PKB), the digital artifact with the additional content as a journal entry for a timeline remembrance.

13. The method of claim 12, further comprising:
retrieving the additional content from at least one stored contextual information comprising one or more communication records associated with the subject information and originating from or directed to a user of the electronic device.

14. The method of claim 12, further comprising:
in response to receiving, via at least one input device, a user trigger to capture the digital artifact, concurrently capturing and/or retrieving at least one of a group comprising: (i) an audio recording; (ii) a video recording; (iii) an image; (iv) a user input description, wherein the additional content is external to the digital artifact.

15. The method of claim 14, further comprising:
in response to identifying a contributor of the additional content that is not the user, storing, as a journal entry in the PKB, an acknowledgement of a contributor of the additional content for the timeline remembrance associated with the digital artifact.

16. The method of claim 15, further comprising:
generating and presenting, via one or more output device, an acknowledgement interface window containing the acknowledgement of the contributor and a control to approve or disapprove of inclusion in the journal entry;
storing the acknowledgement of the contributor with the digital artifact, in response to receiving, via one or more input device, a user input approving the inclusion; and
storing a disapproval record for inclusion of the contributor in response to receiving a user input disapproving the inclusion.

17. The method of claim 12, further comprising:
monitoring user activity at the electronic device related to receiving or generating the contextual information;
capturing the contextual information; and
identifying the additional content from among the stored contextual information, at least in part based on detecting a sequence of connected events leading to capture of the digital artifact based on the contextual information.

18. The method of claim 12, further comprising:
prior to storing the digital artifact with the additional content as a journal entry for a timeline remembrance in the personal knowledge base:
generating and rendering, via one or more output devices, a user interface window containing the additional content and a control for approving or disapproving inclusion of the additional content with the digital artifact;
generating the digital artifact to further comprise the additional content, in response to receiving an approval user input via the one or more input device;
generating and rendering, via the one or more input device, a user interface window containing a manual user input segment for receiving manual entry of additional content; and
in response to receiving the manual entry, via one or more input device, generating the digital artifact to further comprise the additional content.

19. A computer program product comprising:
a computer readable storage device; and
program code on the computer readable storage device that when executed by a processor associated with an electronic device, the program code is configured to cause the electronic device to provide functionality of:
monitoring communication and actions occurring via and around the electronic device for contextual information;
storing a timeline of the contextual information to a repository; and
in response to detecting creation of a digital artifact:
analyzing content of the digital artifact and metadata associated with the digital artifact for subject information;
identifying, from among the stored contextual information, additional content associated with the content and metadata of the digital artifact; and
storing, in a personal knowledge base, the digital artifact with the additional content as a journal entry for a timeline remembrance.

20. The computer program product of claim 19, wherein the program code is further configured to cause the electronic device to provide functionality of:
retrieving the additional content from at least one stored contextual information comprising one or more communication records associated with the subject information and originating from or directed to a user of the electronic device.
